(19) United States
(12) Patent Application Publication
(10) Pub. No.: US 2011/0246970 A1
(43) Pub. Date: Oct. 6, 2011

(54) INTERVAL ANALYSIS OF CONCURRENT TRACE PROGRAMS USING TRANSACTION SEQUENCE GRAPHS

(75) Inventors: Malay GANAI, PLAINSBORO, NJ (US); Chao WANG, PLAINSBORO, NJ (US)

(73) Assignee: NEC LABORATORIES AMERICA, INC., Princeton, NJ (US)

(21) Appl. No.: 13/075,573

(22) Filed: Mar. 30, 2011

Related U.S. Application Data
(60) Provisional application No. 61/318,953, filed on Mar. 30, 2010.

(51) Int. Cl. G06F 9/44

(52) U.S. Cl. 717/132

(57) ABSTRACT

A method for the verification of multi-threaded computer programs through the use of concurrent trace programs (CTPs) and transaction sequence graphs (TSGs).

### CROSS REFERENCE TO RELATED APPLICATIONS

This application claims the benefit of U.S. Provisional Patent Application Ser. No. 61/318,953 filed 30 Mar. 2010.

### FIELD OF DISCLOSURE

This disclosure relates generally to the field of computer software verification and in particular to a method involving the interval analysis of concurrent trace programs using transaction sequence graphs.

### BACKGROUND OF DISCLOSURE

The verification of multi-threaded computer programs is particularly difficult due—in large part—to complex and oftentimes un-expected interleaving between the multiple threads. As may be appreciated, testing a computer program for every possible interleaving with every possible test input is a practical impossibility. Consequently, methods that facilitate the verification of multi-threaded computer programs continue to represent a significant advance in the art.

### SUMMARY OF DISCLOSURE

An advance is made in the art according to an aspect of the present disclosure directed to a method for the verification of multi-threaded computer programs through the use of concurrent trace programs (CTPs) and transaction sequence graphs (TSGs).

Our method proceeds as follows. From a given Concurrent Control Flow Graph (CCFG—corresponding to a CTP), we construct a transaction sequence graph (TSG) denoted as G(V, E) which is a digraph with nodes V representing thread-local control states, and edges E representing either transactions (sequences of thread local transitions) or possible context switches. On the constructed TSG, we conduct an interval analysis for the program variables, which requires O(|E|) iterations of interval updates, each costing O(|V|·|E|) time.

Advantageously, our method provides for the precise and effective interval analysis using TSG as well as the identification and removal of redundant context switches.

For construction of TSGs, we leverage our mutually atomic transaction (MAT) analysis—a partial-order based reduction technique that identifies a subset of possible context switches such that all and only representative schedules are permitted. Using MAT analysis, we first derive a set of so-called independent transactions—that is one which is globally atomic with respect to a set of schedules. Beginning and ending control states of each independent transaction form the vertices of a TSG. Each edge of a TSG corresponds to either an independent transaction or a possible context switch between the inter-thread control state pairs (also identified in MAT analysis). Such a TSG is greatly reduced as compared to the corresponding CCFG, where possible context switches occur between every pair of shared memory accesses.

In sharp contrast to previous attempts that apply the analysis directly on CCFGs—we conduct interval analysis on TSGs which leads to more precise intervals, and more time/space-efficient analysis than doing on CCFGs. Furthermore, the MAT analysis performed according to the present disclosure reduces the set of possible context switches while sumultaneously guaranteeing that such a reduced set captures all necessary schedules.

Advantageously, the method of the present disclosure significantly reduces the size of TSG—both in the number of vertices and in the number of edges—thereby producing more precise interval analysis with improved runtime performance. These more precise intervals—in turn—reduce the size and the search space of decision problems that arise during symbolic analysis.

### BRIEF DESCRIPTION OF THE DRAWING

A more complete understanding of the disclosure may be realized by reference to the accompanying drawing in which:

FIG. 1(a) shows a concurrent system P with threads Mₐ, M_{b} and local variables aᵢ, bᵢ respectively, communicating with shared variable X,Y,Z,L; FIG. 1(b) shows a lattice and a run σ, and FIG. 1(c) shows CTP, as CCFG

FIG. 2(a) shows a CCFG with independent transactions; FIG. 2(b) shows a TSG; and FIG. 2(c) shows traversal on TSG;

FIG. 3(a) shows MATs mᵢ shown as rectangles, obtained using GenMAT; and FIG. 3(b) shows MATs mᵢ shown as rectangles, obtained using GenMAT″

FIG. 4(a) is a flow diagram showing a RPT Range Propagation on a TSG; and FIG. 4(b) is a table showing a sample run of RPT on TSG;

FIG. 5(a) shows a sample run of GenMAT; FIG. 5(b) shows another sample run of GenMAT;

FIG. 6(a) is a MAT generated using GenMAT and FIG. 6(b) is a MAT generated using GenMAT′;

FIG. 7 is a generalized flow/block diagram depicting an overview of a dataflow analysis of concurrent programs according to an aspect of the present disclosure;

FIG. 8 is a generalized flow diagram depicting a more detailed view of the dataflow analysis of FIG. 7 and in particular a dataflow analysis on TSG with bounded updates and local fixed point using sequential dataflow analysis;

### DESCRIPTION OF EMBODIMENTS

The following merely illustrates the principles of the various embodiments. It will thus be appreciated that those skilled in the art will be able to devise various arrangements which, although not explicitly described or shown herein, embody the principles of the embodiments and are included within their spirit and scope.

Furthermore, all examples and conditional language recited herein are principally intended expressly to be only for pedagogical purposes to aid the reader in understanding the principles of the embodiments and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including any functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the FIGs. are conceptual only. Their function may be carried out through the operation of program logic, through dedicated logic, through the interaction of program control and dedicated logic, or even manually, the particular technique being selectable by the implementer as more specifically understood from the context. Finally, any software methods and/or structures presented herein may be operated on any of a number of known processors and or computing systems generally known in the art.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent as those shown herein.

Unless otherwise explicitly specified herein, the drawings are not drawn to scale.

By way of some additional background it is noted that a multi-threaded concurrent program P comprises a set of threads and a set of shared variables, some of which (i.e., locks) are used for synchronization. We let Mᵢ(1≦i≦n) denote a thread model represented by a control and data flow graph of the sequential program it executes. We let Vᵢ be a set of local variables in Mᵢ and [symbol] be a set of (global) shared variables. We let [symbol] be the set of global states of the system, where a state s ε [symbol] is valuation of all local and global variables of the system. A global transition system for P is an interleaved composition of the individual thread models, Mᵢ.

A thread transition t ερ is a 4-tuple (c, g, u, c′) that corresponds to a thread Mᵢ, where c,c′ represent the control states of Mᵢ, g is an enabling condition (or guard) defined on Vᵢ∪ [symbol] , and u is a set of update assignments of the form ν:=exp where variable ν and variables in expression exp belong to the set Vᵢ∪ [symbol] . As per interleaving semantics precisely one thread transition is scheduled to execute from a state.

A schedule of the concurrent program P is an interleaving sequence of thread transitions ρ=t₁ . . . tₖ . In the sequel, we focus only on sequentially consistent ? schedules. An event e occurs when a unique transition t is fired, which we refer to as the generator for that event, and denote it as t=gen(P,e). A run (or concrete execution trace) σ=e₁ . . . eₖ of a concurrent program P is an ordered sequence of events, where each event eᵢ corresponds to firing of a unique transition tᵢ=gen(P,eᵢ). We will illustrate the differences between schedules and runs a bit later in the disclosure.

Let begin(t) and end(t) denote the beginning and the ending control states of t= [symbol] c,g,u,c′ [symbol] , respectively. Let tid(t) denote the corresponding thread of the transition t. We assume each transition t is atomic, i.e., uninterruptible, and has at most one shared memory access. Let Tᵢ denote the set of all transitions of Mᵢ.

A transaction is an uninterrupted sequence of transitions of a particular thread. For a transaction tr=t₁ . . . tₘ, we use |tr| to denote its length, and tr[i] to denote the ^{th} transition for i ε{1, . . . , |tr|}. We define begin(tr) and end(tr) as begin(tr[1]) and end(tr[|tr|]), respectively. Later, we will use the notion of transaction to denote an uninterrupted sequence of transitions of a thread as observed in a system execution.

We say a transaction (of a thread) is atomic w.r.t. a schedule, if the corresponding sequence of transitions are executed uninterrupted, i.e., without an interleaving of another thread in-between. For a given set of schedules, if a transaction is atomic w.r.t. all the schedules in the set, we refer to it as an independent transaction w.r.t. the set. As used herein, the atomicity of transactions corresponds to the observation of the system, which may not correspond to the user intended atomicity of the transactions. Prior works assumed that atomic transactions are system specification that should always be enforced, whereas we infer atomic (or rather independent) transactions from the given system under test, and intend to use them to reduce the search space of symbolic analysis.

Given a run σ for a program P we say e happens-before e′, denoted as e [symbol] _{σ}e′ if i<j, where σ[i]=e and σ[j]=e′, with σ[i] denoting the i^{th} access event in σ. Let t=gen(P,e) and t′=gen(P,e′). We say t [symbol] _{σ}t′ iff e [symbol] _{σ}e′. We use e [symbol] ₚₒ e′ and t [symbol] ₚₒ t′ to denote that the corresponding events and the transitions are in thread program order. We extend the definition of [symbol] ₚₒ to thread local control states such that corresponding transitions are in the thread program order.

Reachable-before relation ( [symbol] ): We say a control state pair (a,b) is reachable-before (a′,b′), where each pair corresponds to a pair of threads, represented as (a,b) [symbol] (a′,b′) such that one of the following is true: 1) a [symbol] ₚₒ a′,b=b′, 2) a=a′,b [symbol] ₚₒb′, 3) a [symbol] ₚₒ a′,b [symbol] ₚₒ b′.

Dependency Relation ( [symbol] ): Given a set T of transitions, we say a pair of transitions (t,t′) εT×T is dependent, i.e. (t,t′) ε [symbol] iff one of the following holds (a) t [symbol] ₚₒ t′, (b) (t,t′) is conflicting, i.e., accesses are on the same global variable, and at least one of them is a write access. If (t,t′) ∉ [symbol] , we say the pair is independent.

Equivalency Relation (≃): We say two schedules ρ₁=t₁ . . . tᵢ·tᵢ₊₁ . . . tₙ and ρ₂=t₁ . . . tᵢ₊₁·tᵢ . . . tₙ are equivalent if (tᵢ,tᵢ₊₁) ∉ [symbol] . An equivalent class of schedules can be obtained by iteratively swapping the consecutive independent transitions in a given schedule. A representative schedule refers to one of such an equivalent class.

Definition 1—Concurrent Trace Program (CTP) A concurrent trace program with respect to an execution trace σ=e₁ . . . eₖ and concurrent program P, denoted as CTP_{σ}, is a partial ordered set (T_{σ}, [symbol] _{σ,po})
T_{σ}={t|t=gen(P,e) where e εσ} is the set of generator transitions
t [symbol] _{σ,po} t′ iff t [symbol] ₚₒ t′∃t,t′εT_{σ}

Let σ=t₁ . . . tₖ be a schedule corresponding to the run σ, where tᵢ=gen(P,eᵢ). We say schedule σ′=t₁′, . . . tₖ′ is an alternate schedule of CTP if it is obtained by interleaving transitions of σ as per [symbol] _{σ,po}. We say σ′ is a feasible schedule iff there exists a concrete trace σ′=e_{1′} . . . e_{k′} where t_{i′}=gen(P,e_{i′}) .

We extend the definition of CTP over multiple traces by first defining a merge operator that can be applied on two CTPs, CTP_{σ} and CTP_{Ψ} as:
(T_{τ}, [symbol] _{τ,po})^{def}=merge((T_{σ}, [symbol] _{σ,po}),(T_{Ψ}, [symbol] _{Ψ,po})) ,

where T_{τ}=T_{σ}∪T_{Ψ} and t [symbol] _{τ,po} t′ iff at least one of the following is true: (a) t [symbol] _{σ,po} t′ where t,t′εT_{σ}, and (b) t [symbol] _{Ψ,po} t′ where t,t′εT_{Ψ}. A merged CTP can be effectively represented as a CCFG with branching structure but no loop. In the sequel, we refer to such a merged CTP as a CTP.

With these definitions in place, we may now more thoroughly describe the method of the present disclosure.

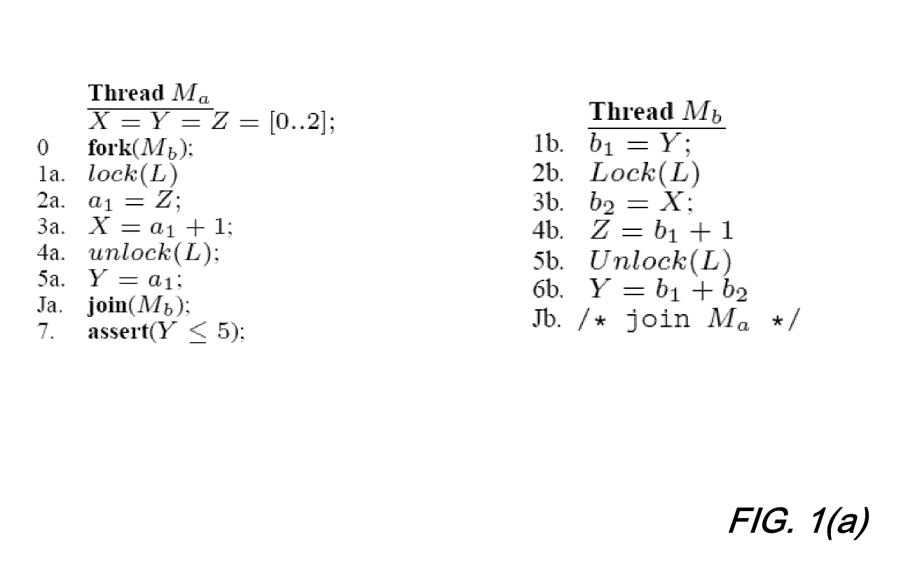

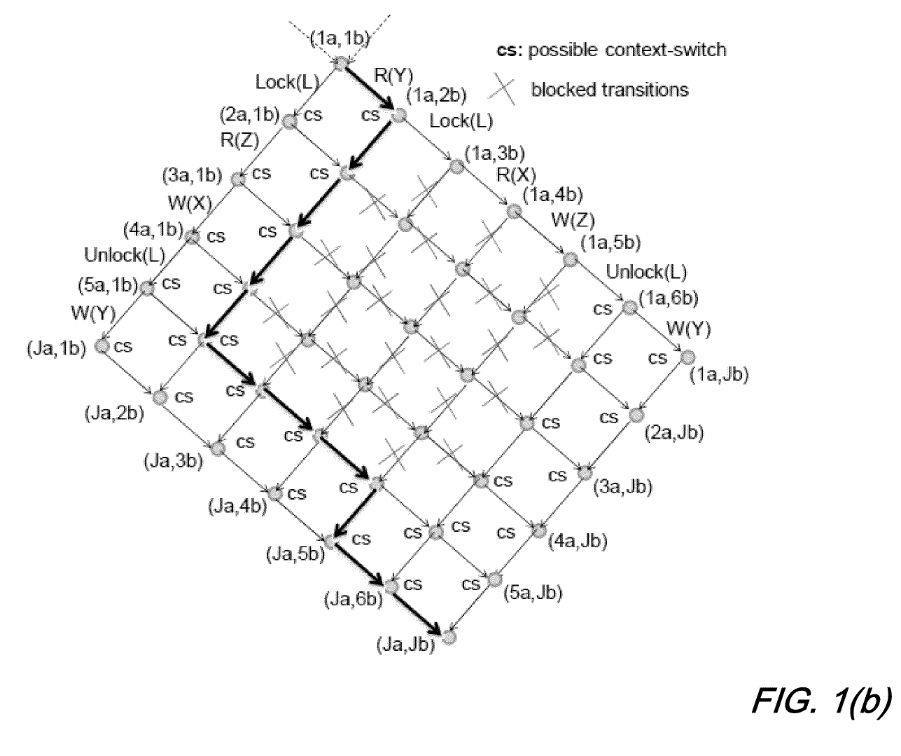

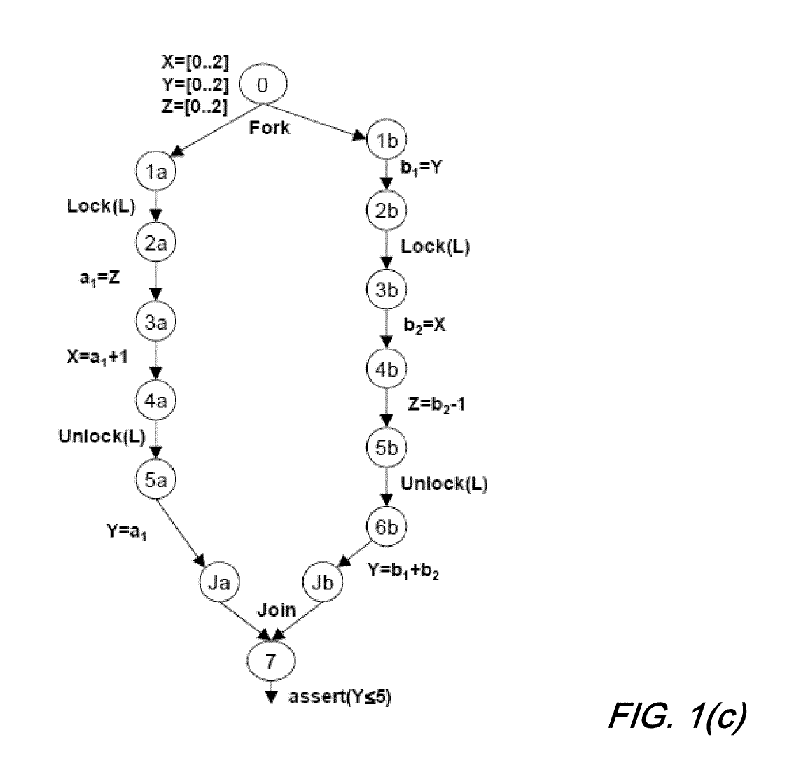

Consider a system P comprising interacting threads Mₐ and M_{b} with local variables aᵢ and bᵢ, respectively, and shared (global) variables X,Y,Z,L. This is shown in FIG. 1(a) where threads are synchronized with Lock/Unlock . Thread M_{b} is created and destroyed using fork join primitives. FIG. 1(b) is the lattice representing the complete interleaving space of the program. Each node in the lattice denotes a global control state, shown as a pair of the thread local control states. An edge denotes a shared event write/read access of global variable, labeled with W(.)/R(.) or Lock(.)Unlock(.). Note, some interleavings are not feasible due to Lock/Unlock, which we crossed out (x) in the figure. We also labeled all possible context switches with cs. The highlighted interleaving corresponds to a concrete execution (run) σ of program P
σ=R(Y)_{b}·Lock(L)ₐ . . . Unlock(L)ₐ·Lock(L)_{b} . . . W(Z)_{b}·W(Y)ₐ·Unlock(L)_{b}·W(Y)_{b} where the suffices a, b denote the corresponding thread accesses.

A thread transition (1b,true,b₁=Y,2b) (also represented as

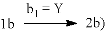

is a generator of access event R(Y)_{b} corresponding to the read access of the shared variable Y. The corresponding schedule ρ of the run σ is

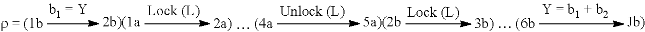

From σ (and ρ), we obtain a slice of the original program called concurrent trace program (CTP). A CTP can be viewed as a generator of concrete traces, where the inter-thread event order specific to the given trace are relaxed. FIG. 1(c) shows the CTP_{σ} of the corresponding run σ shown as a CCFG (This CCFG happens to be the same as P, although it need not be the case). Each node in CCFG denotes a thread control state (and the corresponding thread location), and each edge represents one of the following: thread transition, a context switch, a fork, and a join. So as to not clutter the figure, we do not show edges that correspond to possible context switches (30 in total). Such a CCFG captures all the thread schedules of CTP_{σ}.

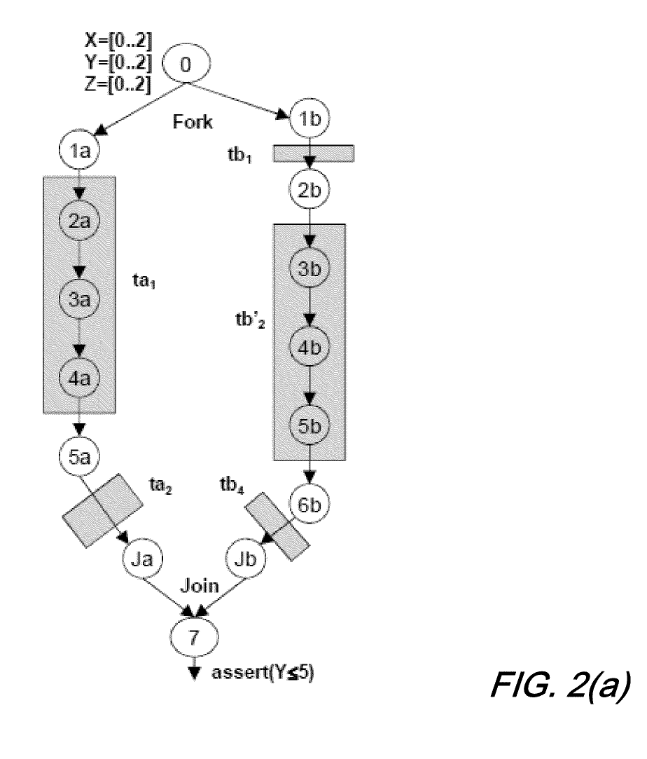

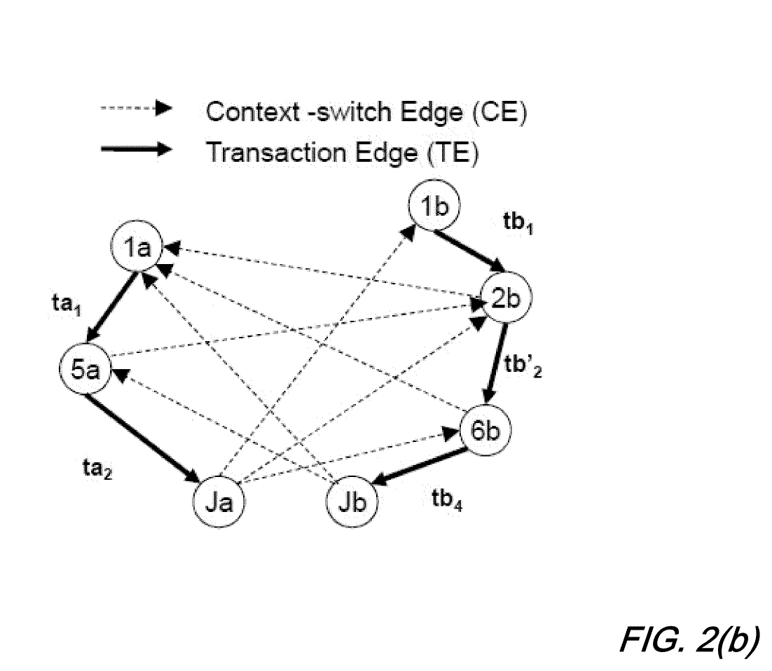

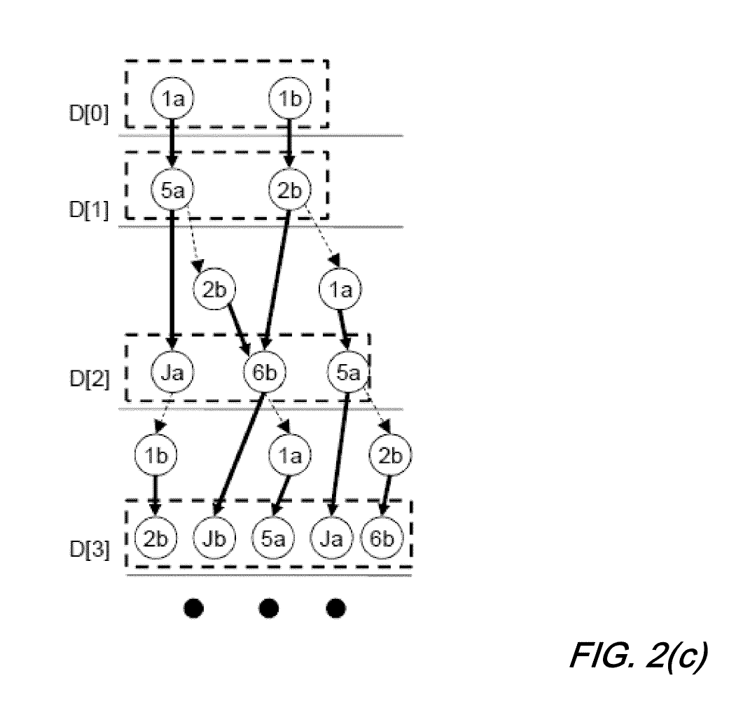

With this disussion of CCFG completed, we are now able to briefly describe the construction of TSG from the CCFG obtained above. Assuming we have computed—using MAT analysis described in the next section—independent transactions sets ATₐ and AT_{b} and necessary context switches for threads Mₐ and M_{b}, where ATₐ={1a . . . 5a,5a·Ja}, AT_{b}={1b·2b,2b . . . 6b,6b·Jb}, and the context switching pairs are {(2b,1a), (Ja,1b)(6b,1a)(5a,2b),(Ja,6b)(Jb,1a)(Ja,2b)(Jb,5a)}. The independent transactions are shown in FIG. 2(a) as shaded rectangles.

Given such sets of independent transactions and context switching pairs, we construct a transaction sequence graph (TSG), a digraph as shown in FIG. 2(b), as follows: the beginning and ending of each independent transaction forms nodes, each independent transaction forms a transaction edge (solid bold edge), and each context-switching pairs forms a context-switch edge (dash edge). We use V, TE, and CE to denote the set of nodes, transaction edges, and context-switch edges, respectively. Such a graph captures all and only the representative interleaving, where each interleaving is a sequence of independent transactions connected by directed edges. The number of nodes (|V|) and the number of transaction edges (|TE|) in TSG are linear in the number of independent transactions, and the number of context-switch edges (|CE|) is quadratic in the number of independent transactions. The TSG shown in FIG. 2(b) has 7 nodes and 13 edges (=5 transaction edges+8 context-switch edges).

If we do not use MAT analysis, a naive way of defining an independent transaction would be a sequence of transitions such that only the last transition has a global access. This is the kind of graph representation used by much of the reported prior work. Later, we refer to a TSG obtained without MAT analysis as a CCFG. Such a graph would have 13 nodes, and 41 edges (=11 transaction edges+30 context-switch edges).

Although TSG may have cycles as shown in FIG. 2(b), the sequential consistency requirement does not permit such cycles in any feasible path. A key observation is that any feasible path will have a sequence of transactions of length at most |TE|. As per the interleaving semantics, any schedule can not have two or more consecutive context switches. Thus, a feasible path will have at most |TE| context switches. For example, path Ja·2b·1a·5a involves two consecutive context switches, and therefore, can be ignored for range propagation. Clearly, one does not require a fixed point computation for range propagation, but rather a bounded number of iterations of size O(|TE|).

Let D[i] denote a set of TSG nodes reachable at BFS depth i from an initial set of nodes. Starting from each node in D[i], we compute range along one transaction edge or along one context switch edge together with its subsequent transaction edge. We show such a traversal on TSG in FIG. 2(c), where dashed and solid edges correspond to context switch and transaction edges, respectively. The nodes in D[i] are shown in dotted rectangles. As a transaction edge is associated with at most one context switch edge, a range propagation would require O(|V|·|TE|) updates per iteration.

We now discuss the essence of MAT analysis used to obtain TSG. Consider a pair (ta^{m}^{₁},tb^{m}^{₁}), shown as the shaded rectangle m₁ in FIG. 1(a), where ta^{m}^{₁}≡Lock(L)ₐ·R(Z)ₐ . . . W(Y)ₐ and tb^{m}^{₁}≡R(Y)_{b} are transactions of threads Mₐ and M_{b}, respectively. For the ease of readability, we use an event to imply the corresponding generator transition.

From the control state pair (1a,1b), the pair (Ja,2b) can be reached by one of the two representative interleavings ta^{m}^{₁}·tb^{m}^{₁} and tb^{m}^{₁}·ta^{m}^{₁}. Such a transaction pair (ta^{m}^{₁},tb^{m}^{₁}) is atomic pair-wise as one avoids interleaving them in-between, and hence, referred as Mutually Atomic Transaction, MAT for short ?. Note that in a MAT only the last transitions pair is dependent. Other MATs m₂ . . . m₇ are similar. A MAT is formally defined as: [Mutual Atomic Transactions (MAT), Ganai 09] We say two transactions trᵢ and trⱼ of threads Mᵢ and Mⱼ, respectively, are mutually atomic iff except for the last pair, all other transitions pairs in the corresponding transactions are independent. Formally, a Mutually Atomic Transactions (MAT) is a pair of transactions, i.e., (trᵢ,trⱼ),i≠j iff ∀k 1≦k≦|trᵢ|,∀h 1≦h≦|trⱼ|, (trᵢ[k],trⱼ[h])∉ [symbol] (k≠|trᵢ|and h≠|trⱼ|), and trᵢ[|trᵢ|],trⱼ[|trⱼ|]) ε [symbol] .

A basic idea of MAT-based partial order reduction is to restrict context switching only between the two transactions of a MAT. A context switch can only occur from the ending of a transaction to the beginning of the other transaction in the same MAT. Such a restriction reduces the set of necessary thread interleavings to explore. For a given MAT α=(fᵢ . . . lᵢ,fⱼ . . . lⱼ), we define a set TP(α) of possible context switches as ordered pairs, i.e., TP(α)={(end(lᵢ),begin(fⱼ)),(end(lⱼ),begin(fᵢ))}. Note that there are exactly two context switches for any given MAT.

Let TP denote a set of possible context switches. For a given CTP, we say TP is adequate iff for each feasible thread schedule of the CTP there is an equivalent schedule that can be obtained by choosing context switching only between the pairs in TP. Given a set [symbol] of MATs, we define TP( [symbol] )= [symbol] TP(α). A set [symbol] is called adequate iff TP( [symbol] ) is adequate. For a given CCFG, one can use an algorithm GenMAT ? to obtain an adequate set of [symbol] that allows only representative thread schedules, as claimed in the following theorem.

Theorem 1 GenMAT generates a set of MATs that captures all (i.e., adequate) and only (i.e., optimal) representative thread schedules. Further, its running cost is O(n²·k²), where n is number of threads, and k is the maximum number of shared accesses in a thread.

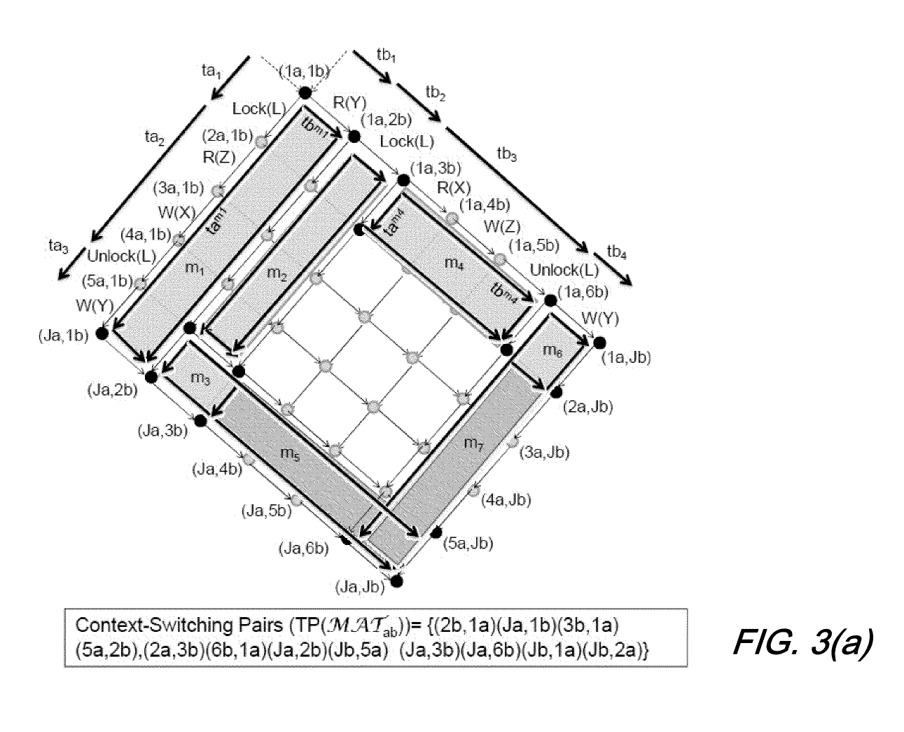

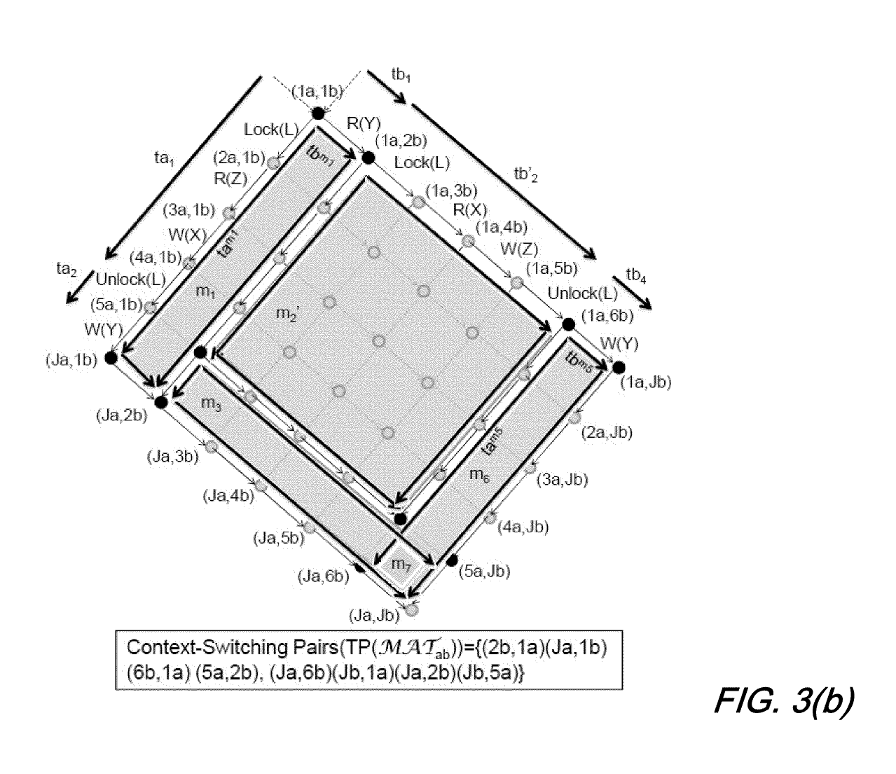

The GenMAT algorithm on the running example proceeds as follows. It starts with the pair (1a,1b), and identifies two MAT candidates: (1a . . . Ja,1b·2b) and (1a·2a,1b . . . 6b) . By giving M_{b} higher priority over Mₐ, it selects the former MAT (i.e., m₁) uniquely. Note that the choice of M_{b} over Mₐ is arbitrary but is fixed through the MAT computation, which is required for the optimality result. After selecting MAT m₁, it inserts in a queue Q, three control state pairs (1a,2b), (Ja,2b),(Ja,1b) corresponding to the begin and the end pairs of the transactions in m₁. These correspond to the three corners of the rectangle m₁. In the next step, it pops out the pair (1a,2b) εQ, selects MAT m₂ using the same priority rule, and inserts three more pairs (1a,3b),(5a,2b),(5a,3b) in Q. Note that if there is no transition from a control state such as Ja, no MAT is generated from (Ja,2b). The algorithm terminates when all the pairs in the queue (denoted as in FIG. 3(a)) are processed. Note that the order of pair insertion can be arbitrary, but the same pair is never inserted more than once.

For the running example, a set [symbol] _{ab}={m₁, . . . m₇} of seven MATs is generated. Each MAT is shown as a rectangle in FIG. 1(a). The total number of context switches allowed by the set, i.e., TP( [symbol] _{ab}) is 12. The highlighted interleaving (shown in FIG. 3(a)) is equivalent to the representative interleaving tb^{m}^{₁}·ta^{m}^{₁}·tb^{m}^{₃} (FIG. 1(a)). One can verify (the optimality) that this is the only representative schedule (of this equivalence class) permissible by the set TP( [symbol] _{ab}).

Reduction of MAT We say a MAT is feasible if the corresponding transitions do not disable each other; otherwise it is infeasible . For example, as shown in FIG. 3(a), MAT m₂=(ta^{m}^{₂},tb^{m}^{₂}) is infeasible, as the interleaving tb^{m}^{₂}·ta^{m}^{₂} is infeasible due to locking semantics, although the other interleaving ta^{m}^{₂}·tb^{m}^{₂} is feasible.

The GenMAT algorithm does not generate infeasible MATs when both the interleavings are infeasible. Such case arises when control state pairs such as (2a,3b) are simultaneously unreachable. However, it generates an infeasible MAT if such pairs are simultaneously reachable with only one interleaving of the MAT (while the other one is infeasible). For example, it generates MAT m₂ as (5a,3b) is reachable with only interleaving Lock(L)ₐ . . . Unlock (L)ₐ·Lock(L)_{b} while the other one Lock(L)_{b}·Lock(L)ₐ . . . Unlock(L)ₐ is infeasible. Such infeasible MAT may result in generation of other MATs, such as m₅ which may be redundant, and m₄ which may be infeasible. Although the interleaving space captured by [symbol] _{ab} is still adequate and optimal, the set apparently may not be “minimal” as some interleavings may be infeasible.

To address the minimality, we modify GenMAT such that only feasible MATs are chosen as MAT candidates. We refer to the modified algorithm as GenMAT′. We use additional static information such as lockset analysis to obtain a reduced set [symbol] _{ab}′ and later show (Theorem 4) that such reduction do not exclude any feasible interleaving. The basic modification is as follows: stating from the pair (begin(fᵢ),begin(fⱼ)), if a MAT (fᵢ . . . lᵢ,fⱼ . . . lⱼ) is infeasible, then we select a MAT (fᵢ . . . l_{i′},fⱼ . . . l_{j′}) that is a feasible, where end(lᵢ) [symbol] ₚₒ end (l_{i′}) or end(lⱼ) [symbol] ₚₒ end(l_{j′}) or both.

With this modified step, GenMAT′ produces a set [symbol] _{ab}′={m₁,m_{2′},m₃,m₆,m₇} of five MATs, as shown in FIG. 1b. Note that infeasible MATs m₂ and m₄ are replaced with MAT m_{2′}. MAT m₅ is not generated as m₂ is no longer a MAT, and therefore, control state pair (5a,3b) is no longer in Q.

The basic intuition as to why m₅ is redundant is as follows: For m₅, we have TP(m₅)={(Ja,2b), (5a,Jb)}. The context switching pair (Ja,2b) is infeasible, as the interleaving allowed by m₅ , i.e., R(Y)_{b}·Lock(L)_{b}·Lock(L)ₐ·W(Y)ₐ·R(X)ₐ . . . is an infeasible interleaving. The other context switching pair (5a,Jb) is included in either TP(m₃) or TP(m₇), where m₃,m₇ are feasible MATs (FIG. 1(b)). The proof that TP( [symbol] _{ab}′) allows the same set of feasible interleavings as allowed by TP( [symbol] _{ab}), is given later.

Independent Transactions Given a set of MATs, we obtain a set of independent transactions of a thread Mᵢ, denoted as ATᵢ, by splitting the pair-wise atomic transactions of the thread Mᵢ as needed into multiple transactions such that a context switching (under MAT-based reduction) can occur either to the beginning or from the end of such transactions. For the running example, the sets of independent transactions corresponding to [symbol] _{ab}′ are ATₐ={1a . . . 5a,5a·Ja} and AT_{b}={1b·2b,2 b . . . 6b,6b·Jb}. These are shown in FIG. 0(a) as shaded rectangles, and are shown as outlines of the lattice in FIG. 3(b). The size of set of independent transaction determines the size of TSGs.

If we used [symbol] _{ab}, we would have obtained ATₐ={1a·2a,2a . . . 5a,5a·Ja} and AT_{b}={1b·2b,2b·3b,3b . . . 6b,6b·Jb}, as shown outlining the lattice in FIG. 3(a). A TSG constructed using [symbol] _{ab} (not shown) would have 8 nodes and 17 edges (=7 transaction edges+10 context-switch edges). Note, out of the 12 context-switches, one can remove (3b,1a) and (2a,3b) as they are simultaneously unreachable.

TSG-based Interval Analysis

We may now present our approach formally. We first discuss MAT reduction step. Then we describe the construction of TSGs followed by interval analysis on TSG. For comparison, we will introduce a notion of interval metric.

Given a CTP with threads M₁ . . . Mₙ, and a dependency relation [symbol] , we use GenMAT ? to generate [symbol] ᵢⱼ for each pair of threads Mᵢ and Mⱼ, i≠j, and obtain [symbol] =∪_{i≠j} [symbol] ᵢⱼ. Note that [symbol] may not include the conflicting pairs that are unreachable. We now define the feasibility of MAT to improve the MAT analysis.

Definition 3 (Feasible MAT) A MAT m=(trᵢ,trⱼ) is feasible such that both representative (non-equivalent) interleavings, i.e., trᵢ·trⱼ and trⱼ·trᵢ, are feasible; otherwise it is infeasible. In other words, in a feasible MAT, the corresponding transitions do not disable each other. We modify GenMAT such that only feasible MATs are chosen as MAT candidates. We denote the modified algorithm as GenMAT′. The modified step is as follows: starting from the pair (fᵢ,fⱼ), if a pair (lᵢ,lⱼ) ε [symbol] is found that yields an infeasible MAT, then
we select another pair (l_{i′},l_{j′}) ε [symbol] such that (lᵢ,lⱼ) [symbol] (l_{i′},l_{j′}) and (fᵢ . . . l_{i′},fⱼ . . . l_{j′}) is a feasible MAT, and
there is no pair (l_{i″},l_{j″}) ε [symbol] such that (lᵢ,lⱼ) [symbol] (l_{i″},l_{j″}) [symbol] (l_{i′},l_{j′}) and (fᵢ . . . l_{i″},fⱼ . . . l_{j″}) is a feasible MAT.
where [symbol] is the reachable-before relation defined before. Interested readers may refer to the complete algorithm in Appendix 7 (also available at ?).

Let [symbol] and [symbol] be the set of MATs obtained using GenMAT and GenMAT′, respectively. We state the following MAT reduction theorem.

Theorem 2 (MAT Reduction) [symbol] is adequate, and TP( [symbol] ) ⊂TP( [symbol] ). The proof is provided in Appendix B.

Transaction Sequence Graph

To build a TSG, we first identify independent transactions of each thread, i.e., those transactions that are atomic with respect to all schedules allowed by the set of MATs, as discussed in the following. Here we use [symbol] to denote the set of MATs obtained.

Identifying Independent Transactions Given a set [symbol] =∪_{i≠jε{1, . . . , n}} [symbol] ᵢⱼ, we identify independent transactions, denoted as ATᵢ as follows:
We first define a set of transactions [symbol] ᵢ of thread Mᵢ:
[symbol] ᵢ={trᵢ|m=(trᵢ,trⱼ) ε [symbol] ᵢⱼi≠j ε{1, . . . , n}}

In other words, [symbol] ᵢ comprises all transactions of thread Mᵢ that are pairwise atomic with some other transactions.
Given two transactions tr,tr′ε [symbol] ᵢ, we say begin(tr) [symbol] ₚₒ begin(tr′) if tr[1] [symbol] ₚₒ tr′[1]. Using the set [symbol] ᵢ, we obtain a partial order set of control states Sᵢ, referred as transaction boundary set, that is defined over [symbol] ₚₒ as follows:
   Sᵢ≡{begin(tr_{i,1}),begin(tr_{i,2}), . . . ,begin(tr_{i,m}),end(tr_{i,m})}
where tr_{i,k} ε [symbol] ᵢ, and tr_{i,m} denote the last transaction of the thread Mᵢ. Note that due to conditional branching the order may not be total.
Using the set Sᵢ, we obtain a set of transactions ATᵢ of thread Mᵢ as follows:

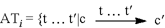

where c [symbol] ₚₒ c′ and c,c′ εSᵢ and t, . . . , t′ εTᵢ and there is no c″εSᵢ such that c [symbol] ₚₒ c″ [symbol] ₚₒ c′}

Recall that T is the set of transitions in Mᵢ.

Proposition 1. Each transaction tr εATᵢ for i ε{1,. . . , n} is an independent transaction and is maximal, i.e., can not be made larger without it being an independent transaction. Further, for each transition t εTᵢ, there exists tr ε ATᵢ such that t εtr .

Constructing TSG Given a set of context-switching pairs TP( [symbol] ), a set of independent transactions ∪ᵢATᵢ, and a set of transaction boundaries ∪ᵢSᵢ, we construct a transaction sequence graph, a digraph G(V ,E) as follows:
V=∪ᵢVᵢ is the set of nodes, where Vᵢ denotes a set of thread local control states corresponding to the set Sᵢ,
E=TE∪CE is the set of edges, where
TE is the set of transaction edges corresponding to the independent transactions i.e., TE={(begin(tr),end(tr))|trε∪ᵢATᵢ}
CE is the set of context switch edges corresponding TP( [symbol] ) i.e., CE={(cᵢ,cⱼ)|(cᵢ,cⱼ)εTP( [symbol] )}

A TSG G (V,E=(CE∪TE)), as constructed, has |V|=O(Σᵢ|ATᵢ|), |TE|=(Σᵢ|ATᵢ|), and |CE|=(Σ_{i≠j}|ATᵢ|·|ATⱼ|), where i,j ε{1, . . . , n}, and n is number of threads. In the worst case, however, |V|=O(n·k), |TE|=O(n·k), and |CE|=O(n²·k²) where k is the maximum number of shared accesses in any thread.

Proposition 2. TSG as constructed captures all and only the representative interleaving (of a given CTP), each corresponding to a total ordered sequence of independent transactions where the order is defined by the directed edges of TSG.

Range Propagation on TSG Range propagation uses data and control structure of a program to derive range information. In this work, we consider intervals for simplicity, although other abstract domains are equally applicable. For each program variable ν, we define an interval [symbol] l_{ν}^{c},u_{ν}^{c} [symbol] , where l_{ν}^{c}, l_{ν}^{c} are integer-valued lower and upper bounds for ν at a control location c. One can define, for example, the lower bound(L)/upper bound (U) of an expression exp=exp₁+exp₂ at a control location c as L(exp,c)=L(exp₁,c)+L(exp₂,c) and U(exp,c)=U(exp₁,c)+U(exp₂,c) , respectively.

We say an interval [symbol] l_{ν}^{c},u_{ν}^{c} [symbol] is adequate if value of ν at location c, denoted as val(ν,c) is bounded in all program executions, i.e., l_{ν}^{c}≦val(ν,c)≦u_{ν}^{c}. As there are potentially many feasible paths, range propagation is typically carried out iteratively along bounded paths, where the adequacy is achieved conservatively. However, such bounded path analysis can still be useful in eliminating paths that do not satisfy sequential consistency requirements. As shown in FIG. 2(c), a sequence 5a ·2b ·6b·1a does not follow program order, and therefore, paths with such a sequence can be eliminated.

At an iteration step i of range propagation, let r^{c,p}[i] denote the range information (i.e., a set of intervals) at node c along a feasible path p, and is defined as:
r^{c,p}[i]={ [symbol] l_{ν}^{c,p}[i]u_{ν}^{c,p}[i] [symbol] | interval for ν computed at node c along path p at step i}

One can merge r^{c,p}[i] and r^{c,p′}[i] conservatively as follows:
r^{c,p}[i]␣r^{c,p′}[i]={ [symbol] l_{ν}^{c,p}[i],u_{ν}^{c,p}[i] [symbol] ␣ [symbol] l_{ν}^{c,p′}[i],u_{ν}^{c,p′}[i] [symbol] | interval for ν computed at node c along paths p,p′ at step i}
where the interval merge operator (␣) is defined as: [symbol] l,u [symbol] ␣ [symbol] l′,u′ [symbol] = [symbol] min(l,l′),max(u,u′) [symbol] .

Let r^{c}[i] denote the range information at node c at step i, i.e.,
r^{c}[i]={ [symbol] l_{ν}^{c}[i],u_{ν}^{c,p} [i] [symbol] | interval for ν computed at node c at iteration step i}.

Let FP denote a set of feasible paths starting from nodes D[i] of length B≧1, where B is a lookahead parameter that controls the trade off between precision and update cost. Given r^{c,p}[i] with p εFP, we obtain the range information at step i as r^{c}[i]=␣i_{pεFP} r^{c,p}[i] and cumulative range information at step i as R^{c}[i]=␣ⱼ₌₀^{j=i}r^{c}[j].

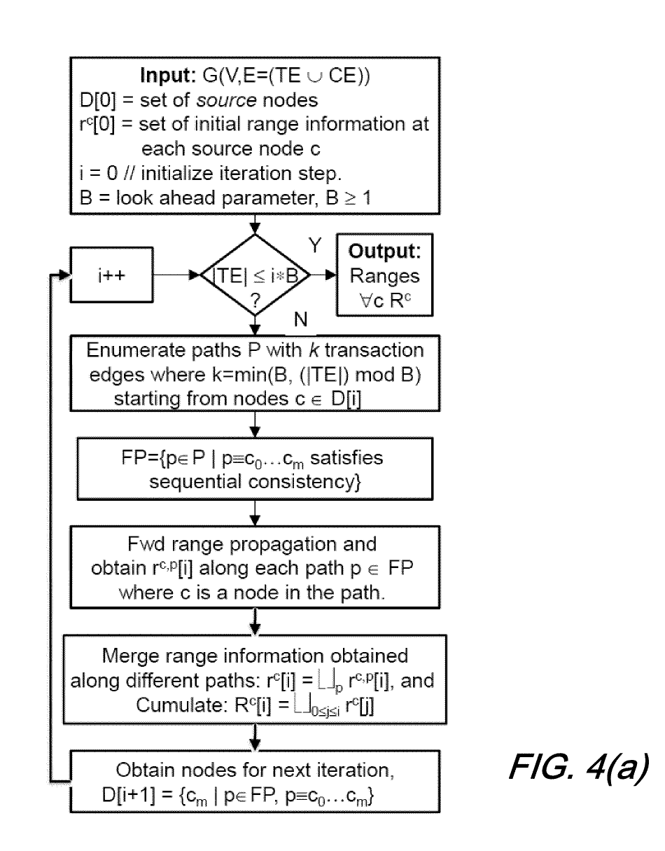

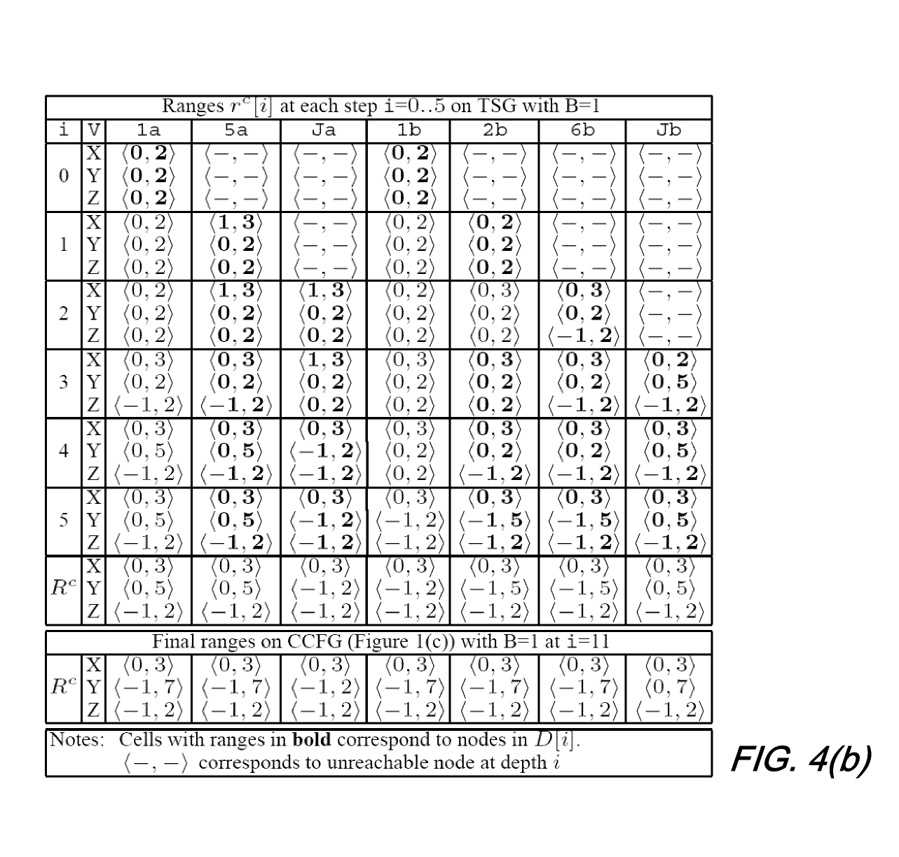

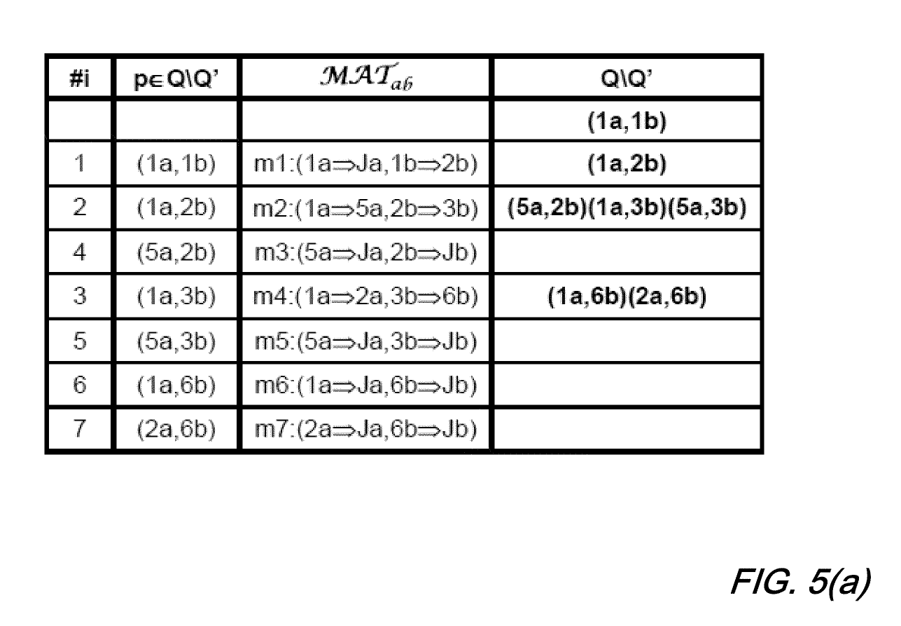

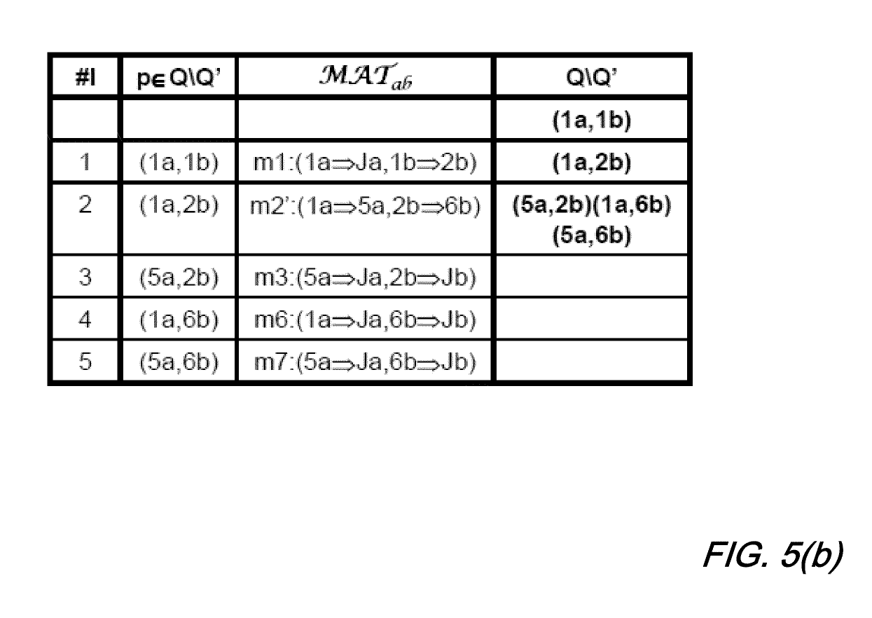

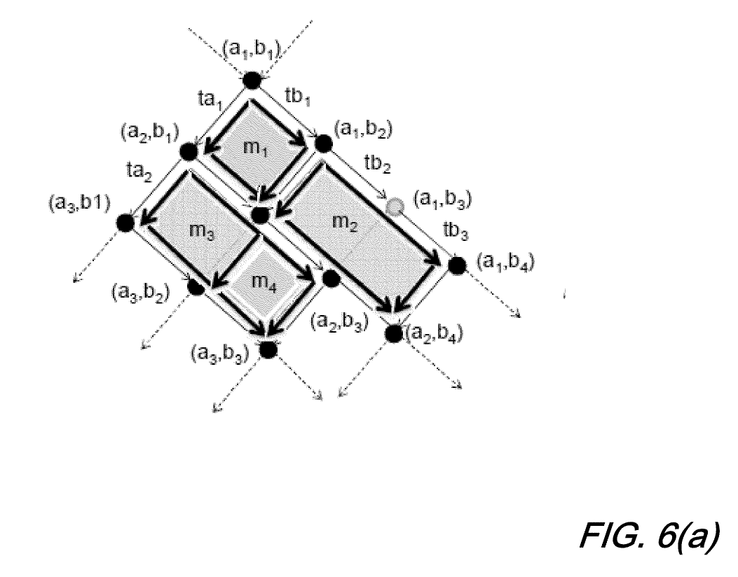

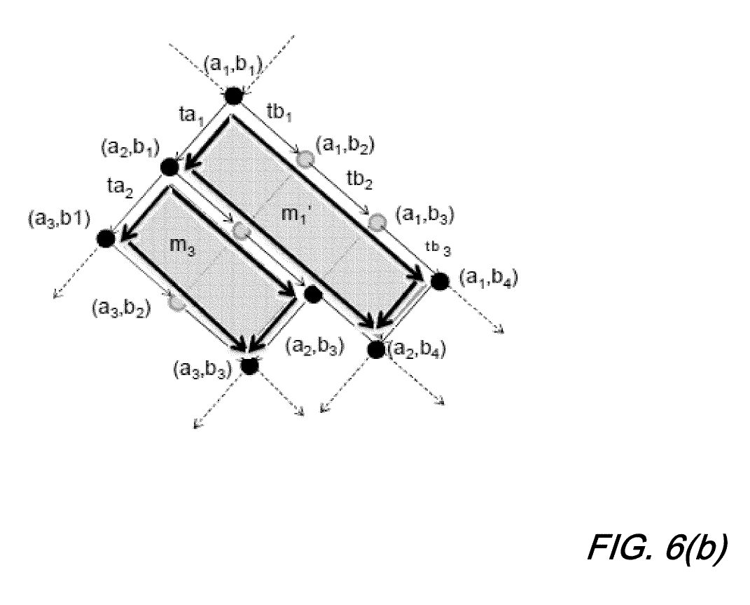

We present a self-explanatory flow of our forward range propagation procedure, referred as RPT, for a given TSG G=(V,E) in FIG. 4(a). As observed previously, in any representative feasible path, a transaction edge is associated with at most one context switch edge. Thus, the length of such a path is at most 2·|TE|. At every iteration of range propagation, we compute the range along a sequence of |B| transaction edges interleaved with at most |B| context switch edges. Such a range propagation requires ┌|TE|/B┐ iterations. The cost of range propagation at each iteration is O(|V|·|TE|^{B}) . After RPT terminates, we obtain the final cumulative range information R^{c}[i] at each node c, denoted as R^{c}.

Proposition 3. Given a TSG G=(V,E=(TE∪CE)) that captures all feasible paths of a CTP, the procedure RPT generates adequate range information R^{c} for each node c εV, and the cost of propagation is O(|V |·TE|^{B+1}).

We show a run of RPT in FIG. 4(b) on the TSG shown in FIG. 2(b). At each iteration step i, we show the range computed r^{c}[i] (for each global variable) at the control states 1a,5a,Ja,1b,2b,6b,Jb. Since there are 5 TE edges in the TSG, we require 5 iterations with B=1. The cells with [symbol] -,- [symbol] correspond to no range propagation to those nodes. The cells in bold at step i correspond to nodes in D[i]. The final intervals at each node c, i.e., R^{c}, is equal to the data-union of the range values at c computed at each iteration i=1 . . . 5. We show the corresponding cumulative intervals obtained for the CCFG after 11 iterations (as it has 11 TE edges). Note that using TSG, RPT not only obtains more refined intervals, but also requires fewer iterations. Also observe that the assertion Y≦5 (line 7, FIG. 1(a)) holds at Jb with the final intervals for Y obtained using TSG, while it does not hold at Jb when obtained using CCFG.

Interval Metric

Given the final intervals [symbol] l_{ν}^{c},u_{ν}^{c} [symbol] εR^{c}, we use the total number of bits needed (the fewer the better) to encode each interval, as a metric to compare effectiveness of interval analysis on CCFG and TSGs. We refer to that as interval metric. It has two components: local (denoted as RBₗ) and global (denoted as RB_{g}) corresponding to the total range bits of local and global variables, respectively. The local component RB is computed as follows:

RB₁=Σ_{tε}∪ᵢ^{T}_{ⁱ}Σ_{νεassgn}_{ₗ}^{(t)}log₂(u_{ν}^{end(t)}−l_{ν}^{end(t)}).

where assgnₗ(t) denotes a set of local variables assigned (or updated) in transition t.

For computing the global component RB_{g}, we need to account for context switching that can occur between global updates. Hence, we add a synchronization component, denoted as RB_{g}^{sync}, in the following:

RB_{g}=Σ_{tε}∪ᵢ^{T}_{ⁱ}Σ_{νεassgn}_{_{g}}^{(t)}log₂(u_{ν}^{end(t)}−l_{ν}^{end(t)})+RB_{g}^{sync}

where assgn_{g}(t) denotes a set of global variables assigned in transition t, and RB_{g}^{sync} is the synchronization component corresponding to a global state before an independent transaction begins, and is computed as follows:

RB_{g}^{sync}=Σ_{trε}∪ᵢ^{AT}_{ⁱ}Σ_{νεν}log₂(u_{ν}^{begin(tr)}−l_{ν}^{begin(tr)})

where νε [symbol] is a global variable, and tr is an independent transaction.

For the running example, the interval metrics obtained are as follows: CCFG: RBₗ=8,RB_{g}=95 ; TSG using [symbol] _{ab}: RBₗ=6,RB_{g}=57; TSG using [symbol] _{ab}′: RBₗ=6,RB_{g}=43.

Experiments

In our experiments, we use several multi-threaded benchmarks of varied complexity with respect to the number of shared variable accesses. There are 4 sets of benchmarks that are grouped as follows: simple to complex concurrent programs (cp), our Linux/Pthreads/C implementation of atomicity violations reported in apache server ? (atom), bank benchmarks (bank), and indexer benchmarks (index). Each set has concurrent trace programs (CTP) generated from the runs of the corresponding concurrent programs. These benchmarks are publicly available. We used constant propagation algorithm to preprocess these benchmarks in order to expose the benefits of our approach.

Our experiments were conducted on a linux workstation with a 3.4 GHz CPU and 2 GB of RAM, and a time limit of 20 minutes. From these benchmarks, we first obtained CCFG. Then we obtained TSG and TSG′ after conducting MAT analysis on the CCFGs, using GenMAT and GenMAT′, respectively, as described previously. For all three graphs, we removed context switch edges between node pairs that are found unreachable using lockset analysis.

Comparison of RPT on CCFG, TSG, and TSG′ are shown in Table 3 using lookahead parameter B=1. The characteristics of the corresponding CTPs are shown in Columns 2-6, the results of RPT on CCFG , TSG and TSG′ are shown in Columns 7-11, and Columns 12-17, and Columns 18-23, respectively. Columns 2-6 describe the following: the number of threads (n), the number of local variables (#L), the number of global variables (#G), the number of global accesses (#A), and the number of total transitions (#T), respectively. Columns 7-11 describe the following: the number of context switch edges (#CE), the number of transaction edges (#TE) (same as the number of iterations of RPT), the time taken (t, in sec), the number of local bits RB, and number of global bits RB_{g}, respectively. Columns 12-17 and 18-23 describe similarly for TSG and TSG′ including the number of MATs obtained (#M). In case of CCFG, we obtained a transaction by combining sequence of transitions such that only the last transition has exactly one global access. The time reported includes MAT analysis (if performed) and run time of RPT.

As we notice, RPT on TSG and TSG′(except index4) completes in less than a minute, and is an order of magnitude faster compared to that on CCFG. Also, the interval metric (RAₗ,RB_{g}) for TSG and TSG′ are significantly lower compared to CCFG. Further, between TSG′ and TSG, the former generates tighter intervals.

We also evaluated reduction in the efforts of a heavy-weight trace-based symbolic analysis tool CONTESSA using RPT results. For each benchmark, we selected a reachability property corresponding to a reachability of a thread control state. Using the tool, we then generated Satisfiability Modulo Theory (SMT) formula such that the formula is satisfiable if and only if the control state is reachable. We then compared the solving time of two such SMT formula, one encoded using the bit-widths of variables as obtained using RPT (denoted as φ_{R}), and other encoded using integer bit-width of 32 (denoted as φ₃₂). We observed that the solving on φ_{R} is faster than on φ₃₂ by about 1-2 orders of magnitude. Further details are available in our technical report.

Conclusion

We have presented an interval analysis for CTPs using the new notion of TSGs, which is often more precise and space/time efficient than using the standard CCFGs. We use a MAT analysis to obtain independent transactions and to minimize the size of the TSGs. We also propose a non-trivial improvement to the MAT analysis to further simplify the TSGs. Our work is related to the prior work on static analysis for concurrent programs, although such analysis were directly applied to the CCFG of a whole program. Our notion of TSG is also different from the transaction graph (TG) and the task interaction concurrency graph (TICG) that have been used in concurrent data flow analysis. Such graphs, i.e, TG and TICG, represent a product graph where nodes correspond to the global control states and edges correspond to thread transitions—such graphs are often significantly bigger in size than TSGs.

MAT Generation Algorithm

We present the algorithm GenMAT40 (Algorithm 1), where we use OLD/NEW predicate to show the difference between previous ? and our proposed improvements, respectively.

Given a CTP with threads M₁ . . . Mₙ, and a dependency relation D, we use GenMAT′ to generate [symbol] ᵢⱼ for each pair of threads Mᵢ and Mⱼ, i≠j, and obtain [symbol] =∪_{i≠j} [symbol] ᵢⱼ. Note that D may not nclude the conflicting pairs that are unreachable.

For the ease of explanation, we assume there is no conditional branching in each thread. We also assume that each shared variable has at least one conflicting accesses in each pair of threads. (Such an assumption can be easily met by adding a dummy shared write access at the end of each thread without affecting the cost of MAT analysis. Note that such an assumption is needed for the adequacy and optimality for validity of Theorem 2 for a multi-threaded system).

With abuse of notation, we use transition t to also indicate begin(t), the control state of the thread where the transition t begins. Further, we use +t to denote the transition immediately after t in program order, i.e., begin(+t) =end(t).

We discuss the inner loop (lines 15--18) to generate [symbol] ᵢⱼ for a thread pair Mᵢ and Mⱼ, i≠j . Let (├ᵢ,├ⱼ) and (┤ᵢ,┤ⱼ) denote the start and end control pair locations, respectively, of the threads Mᵢ and Mⱼ. We first initialize a queue Q with control state pair (├ᵢ,├ⱼ) representing the beginning of the threads, respectively. For a previously unchosen pair (fᵢ,fⱼ) in the Q, we can obtain a MAT m=(trᵢ=fᵢ . . . lᵢ,trⱼ=fⱼ . . . lⱼ). There can be other MAT-candidates m′=(trᵢ′=fᵢ . . . lᵢ′,tr′ⱼ=fⱼ . . . lⱼ′) such that lᵢ′ [symbol] ₚₒ lᵢ or lⱼ′ [symbol] ₚₒ lⱼ but not both, as that would invalidate m as a candidate. Let M_{c} denote a set of such choices as obtained using the method OLD. Using our proposed method NEW, we will restrict our choices to feasible MAT candidates only.

The algorithm selects m ε [symbol] , uniquely by assigning thread priorities and using the following selection rule. If a thread Mⱼ is given higher priority over Mᵢ, the algorithm prefers m=(tr=fᵢ . . . lᵢ,trⱼ=fⱼ . . . lⱼ) over m′=(tr_{j′}=fᵢ . . . l_{i′},tr_{j′}=fᵢ . . . l_{j′}) if lⱼ [symbol] ₚₒ l_{j′}, i.e., |trⱼl|<|tr_{j′}|. The choice of Mⱼ over Mᵢ is arbitrary but fixed through the MAT computation, which is required for the optimality result. We presented MAT selection (lines 10--11) in a declarative style for better understanding. However, algorithm finds the unique MAT using the selection rule, without constructing the set [symbol] _{c}.

We add m to the set [symbol] ᵢⱼ. If (+lᵢ≠┤ᵢ) and (+lⱼ≠┤ⱼ), we update Q with three pairs, i.e., (+lᵢ,+lⱼ),(+lᵢ,fⱼ),(fᵢ,+lᵢ); otherwise, we insert selectively as shown in the algorithm (lines 14---16). The algorithm terminates when all the pairs in the queue are processed. Note that the order of pair insertion can be arbitrary, but the same pair is never inserted more than once.

A run of GenMAT : We present a run of GenMAT (OLD) in FIG. 1(a) for the running example. We gave M₂ higher priority over M₁. The table columns provide each iteration step (#I), the pair p εQ\Q′ selected, the chosen [symbol] _{ab} , and the new pairs added in Q\Q′ (shown in bold). It starts with the pair (1a,1b), and identifies two MAT candidates: (1a . . . Ja,1b·2b) and (1a·2a,1b . . . 6b). Note that the pair (1a·2a,1b . . . 3b) is not a MAT candidate as the pair (2a,3b) is an unreachable pair. By giving M_{b} higher priority over Mₐ, it selects a MAT uniquely from the MAT candidates. The choice of M_{b} over Mₐ is arbitrary but fixed through the MAT computation, which is required for the optimality result. After selecting MAT m₁, it inserts in a queue Q, three control state pairs (1a,2b),(Ja,2b),(Ja,1b) corresponding to the begin and the end pairs of the transactions in m₁ . These correspond to the three corners of the rectangle m₁. In the next step, it pops out the pair (1a,2b) εQ, selects MAT m₂ using the same priority rule, and inserts three more pairs (1a,3b),(5a,2b),(5a,3b) in Q. Note that if there is no transition from a control state such as Ja, no MAT is generated from (Ja,2b). Also, if a pair such as (2a,2b) is unreachable, no MAT is generated from it. One may not insert such pair in the first place. The algorithm terminates when all the pairs in the queue (denoted as in FIG. 1(a)) are processed.

Note that the order of pair insertion can be arbitrary, but the same pair is never inserted more than once. For the running example, a set [symbol] _{ab}={m₁, . . . m₇} of seven MATs is generated. Each MAT is shown as a rectangle in FIG. 1(a). The total number of context switches allowed by the set, i.e., TP( [symbol] _{ab}) is 12.

A run of GenMAT': We present a run of GenMAT′ (NEW) in FIG. 1(b) for the same running example. The table columns have similar description. In the second iteration, starting from the pair (1a,2b) , the infeasible MAT (1a . . . 5a,2b . . . 3b) is ignored as the interleaving 2a . . . 3b·1a . . . 5a is infeasible. As (1a,3b) is no longer in Q, m₄ is not generated (which is infeasible). Similarly, as (5a,3b) is no longer in Q, m₅ is not generated (which is feasible). There are 5 MATs m₁,m_{2′},m₃,m₆,m₇ generated, shown as rectangles in FIG. 1(b). The total number of context switching allowed by the set is 8.

GenMAT′: Obtain a set of MATs

[1] input: Thread Models: M₁ . . . Mₙ; Dependency Relation D output: [symbol] pairs of thread (Mᵢ, Mⱼ) [symbol] ᵢⱼ:=Ø; Q :={(├ᵢ,├ⱼ)}; Q′:=Ø Initialize Queue; Q\Q′≠Ø Select (fᵢ,fⱼ) εQ\Q′ Q:=Q\{(fᵢ,fⱼ)}; Q′:=Q′∪{(fᵢ,fⱼ)}

if OLD MAT-candidates set, [symbol] _{c}={m|m is MAT from (fᵢ,fⱼ)}? if NEW MAT-candidates set, [symbol] _{c}={m|m is feasible MAT from (f ᵢ,fⱼ)} Select a MAT m=(trᵢ=fᵢ . . . lᵢ,trᵢ=fⱼ . . . lⱼ) ε [symbol] _{c} such that ∀m′=(trᵢ′,trⱼ′) ε [symbol] _{c}, m′≠m|trⱼ51 <tr′ⱼ|, (i.e., Mⱼ has higher priority). [symbol] ᵢⱼ:= [symbol] ᵢⱼ ∪{m} if (+lᵢ=┤ᵢ [symbol] +lⱼ=┤ⱼ) then continue; elseif (+lᵢ=┤ᵢ) then q:={(fᵢ,+lⱼ)}; elseif (+lⱼ=┤ⱼ) then q:={(+lᵢ,fⱼ)}; else q:={(+lᵢ,+lⱼ),(+lᵢ,fⱼ),(fᵢ,lⱼ)}; Q:=Q∪q; [symbol] := [symbol] ∪ [symbol] ᵢⱼ

[symbol]

FIG. 2: (a) Run of (a) GenMAT and (b) GenMAT′ on example in FIG. 0

MAT Reduction Theorem Let [symbol] and [symbol] be the set of MATs obtained using GenMAT and GenMAT′, respectively.

Theorem 1 (MAT reduction) [symbol] is adequate, and TP( [symbol] ) ∪TP( [symbol] ).

Proof. Consider a pair of threads Mₐ and M_{b} such that the chosen priority of Mₐ is higher than M_{b}. Let (a₁,b₁) be a pair picked at line 6, and the corresponding MAT selected by GenMAT be m₁=(ta₁,tb₁). GenMAT algorithm then inserts pairs (a₂,b₁), (a₁, b₂), and (a₂,b₂) in the worklist Q, shown as in FIG. 2(a). Assume that tb₁ disables ta₁, i.e., tb₁·ta₁ is an infeasible interleaving, and rest are feasible interleaving. Thus, m₁ is an infeasible MAT. Continuing the run of GenMAT, we have the following MAT:
m₂=(ta₁,tb₂·tb₃) from the pair (a₁,b₂) ,
m₃=(ta₂,tb₁·tb₂) from the pair (a₂,b₁) ,
m₄=(ta₂,tb₂) from the pair (a₂,b₂) .

Note, since tb₁ disables ta₁, there exists some tb₂·tb₃ that enables ta₁, such that its last transition have a conflicting access with that of ta₁. (If not, one observe that any interleaving of the form tb₁ . . . tbⱼ·ta₁ is infeasible. In that case we will not have m₂). Also, since Mₐ is prioritized higher, we have the MAT m₃ with |tb₂|≧0. The context switching allowed by MATs m₁ . . . m₄ are
TP({m₁,m₂,m₃,m₄})={(b₂,a₁),(a₂,b₁),(a₂,b₂)(b₄,a₁)(a₃,b1)(b₃,a₂)(a₃,b₂)}.

Now we consider the corresponding run of GenMAT′ from (a₁,b₁) where only feasible MATs are generated. Such a run would produce MATs
m_{1′}=(ta₁,tb₁·tb₂·tb₃) from the pair (a₁,b₂),
m₃=(ta₂,tb₁·tb₂) from the pair (a₂,b₁) .

The context switching allowed by MATs m_{1′l ,m}₃ are

In the rest of the proof discussion, we consider the interesting case where |tb₂|>0. (A similar proof discussion can be easily made for the other case |tb₂|=0.) All the interleaving I₁-I₁₁ (including the infeasible ones), as allowed by MAT m₁,m₂,m₃,m₄, are shown as follows:

| | | | |
|---|---|---|---|
| I₁: | . . . ta₁ · ta₂ . . . | | |
| I₂: | . . . tb₁ · tb₂ · tb₃ . . . | | |
| I₃: | . . . ta₁ · ta₂ · tb₁ · tb₂ . . . | | allowed by {m₃} |
| I₄: | . . . ta₁ · tb₁ · tb₂ · ta₂ . . . | | allowed by {m₁, m₃} |
| I₅: | . . . ta₁ · tb₁ · tb₂ · tb₃ . . . | | allowed by {m₁} |
| I₆: | . . . tb₁ · tb₂ · tb₃ · ta₁ . . . | | allowed by {m₂} |
| I₇: | . . . tb₁ · ta₁ · ta₂ . . . | (infeasible) | allowed by {m₁} |
| I₈: | . . . tb₁ · ta₁ · ta₂ · tb₂ . . . | (infeasible) | allowed by {m₁, m₄} |
| I₉: | . . . tb₁ · ta₁ · ta₂ . . . | (infeasible) | allowed by {m₁} |
| I₁₀: | . . . tb₁ · ta₁ · tb₂ . . . | (infeasible) | allowed by {m₁, m₂} |
| I₁₁: | . . . tb₁ · ta₁ · tb₂ · ta₂ . . . | (infeasible) | allowed by {m₁, m₂, m₄} |

One can verify that all but infeasible interleavings, i.e., I₁-I₆, are also captured by m₂, and m₃.

All the pairs that are inserted in Q are shown using in the FIGS. 2(a)-(b). After the MATs {m₁,m₂,m₃,m₄} are selected (by GenMAT), the following pairs in Q that are yet to be processed are
Q\Q′={(a₃,b₁),(a₃,b₂),(a₃,b₃),(a₂,b₃),(a₂,b₄)(a₁,b₄)}

Similarly, after the MATs {m_{1′},m₃} are selected (by GenMAT′) , the following pairs in Q that are yet to be processed are
Q\Q′={(a₃,b₁),(a₃,b₃),(a₂,b₃),(a₂,b₄)(a₁,b₄)}.

Note that MAT from (a₃,b₂) , as selected in GenMAT, allows exclusively an interleaving . . . tb₁·ta₁·ta₂. . . ; however such an interleaving is infeasible. For the remaining pairs we apply our argument inductively to show that from a control state pair, one can obtain a set of MATs from both GenMAT and GenMAT′ respectively, that allow the same set of feasible interleaving. These arguments show the adequacy of our claim.

Further, GenMAT′ inserts in the worklist a set of pairs that is a subset of pairs inserted by GenMAT. The claim TP( [symbol] ) ⊂TP( [symbol] ) trivially holds as the worklist set is smaller with GenMAT′ as compared to GenMAT. Thus, the interleaving space captured by [symbol] is not increased. As [symbol] captures only representative schedules as per Theorem 2, clearly, [symbol] captures only representative schedules.

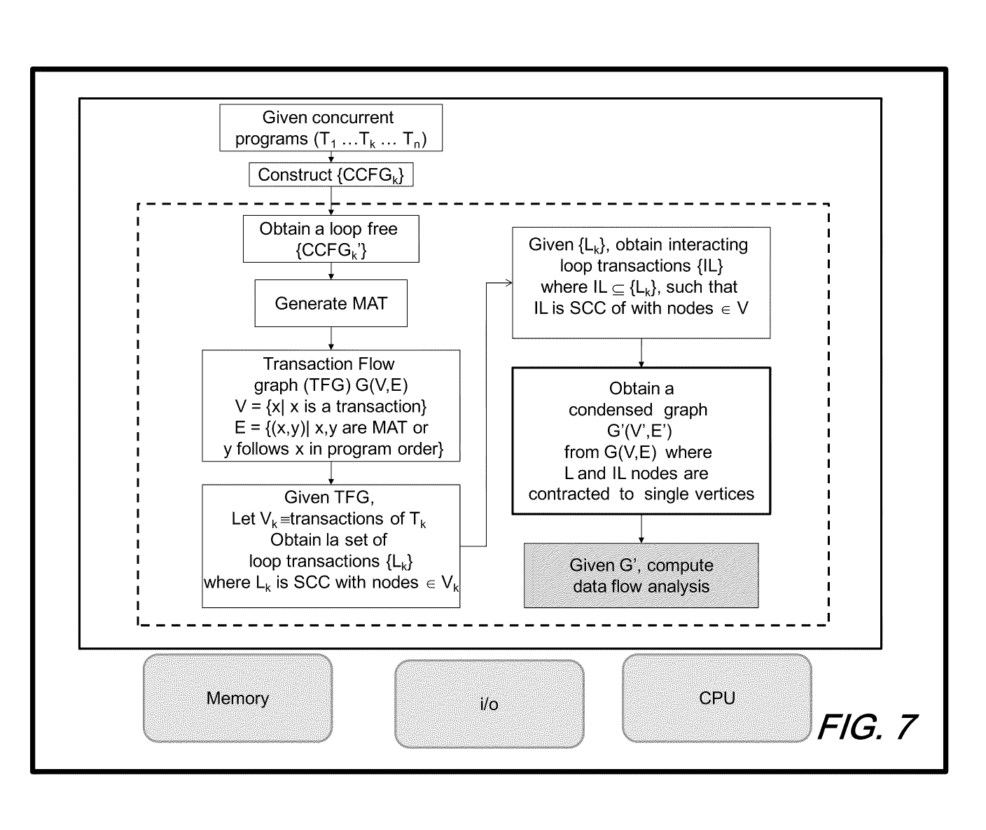

Turning now to FIG. 7 there is shown a flow diagram depicting an overview of the dataflow analysis according to the present disclosure. We begin with a computer program or portion having a set of interacting concurrent program threads T₁ . . . Tₙ, communicating using shared variables and synchronization primitives (block 1).

Next, we generate a concurrent control flow graph {CCFGₖ} for each thread Tₖ, where CFG for each thread is constructed independently wherein dependency edges between the control states that are interleaving (block 2).

We obtain {CCFG′ₖ} by removing loop backedges, and replacing them with edges to dummy nodes with global accesses in the corresponding loops (block 3).

For each pair threads Tₐ and T_{b}, we obtain a set of pair (thread) control locations C_{ab} with shared accesses that are in conflict, i.e., accesses are on the same variable. For two threads, we add additional constraint that one of the accesses is write. From the set C_{ab}, we remove the pairs that are unreachable simultaneously due to i) happens-before must relation, ii) mutual exclusion, iii) lock acquisition pattern. For each thread pairs Tₐ and T_{b}, and corresponding set C_{ab}, we identify a set M_{ab} of Mutually Atomic Transactions (MAT). Each MAT mεM_{ab} is represented as (x [symbol] cₐ, y [symbol] c_{b}) where x [symbol] cₐ denote atomic transition from location x to cₐ in thread Tₐ, and y [symbol] c_{b} denote atomic transition from location y to c_{b} in thread T_{b}, such that there is no conflict access other than at locations cₐ and c_{b}, and no transition is disabled which may be due to synchronization events such as fork/join and wait/notify or due to dataflow facts. Such a MAT is referred as feasible MATs. (block 4)

We exploit the pair-wise transactions of MATs to obtain independent transactions, i.e. those transactions that are atomic with respect to all other MAT transactions. Such a set is obtained by splitting the transactions of MAT as needed into multiple transactions such that (a) each of them are independent transactions, (b) the context switches (under MAT-based reduction) can occur at the start, the end or both of such transaction. Given such a set of independent transactions, we construct Transaction Sequence Graph G(V,E) where V is a set of thread local control nodes and E is the set of directed edges of type either a transaction edge or context-switching edge. The transaction edge corresponds to independent transaction, and context-switching edge corresponds to the context switching between inter thread control states as provided by MAT analysis. (block 5)

Given TSG G(V,E), we define Vₖ(⊂ V) a set of control nodes of thread Tₖ. We identify a set of loop transactions {Lₖ} where Lₖ is an SCC with nodes belonging to Vₖ only. Note that this corresponds to a program loop.

Given {Lₖ}, we obtain a set of interacting loop transactions {IL} where IL (⊂ {Lₖ}) is an SCC with nodes belonging to V. Note that IL includes one or more loop transactions from different threads.

Next, we obtain G′(V′,E′) a condensed transaction sequence graph where each Lₖ and IL are contracted with a single edge that represents the loop summary.

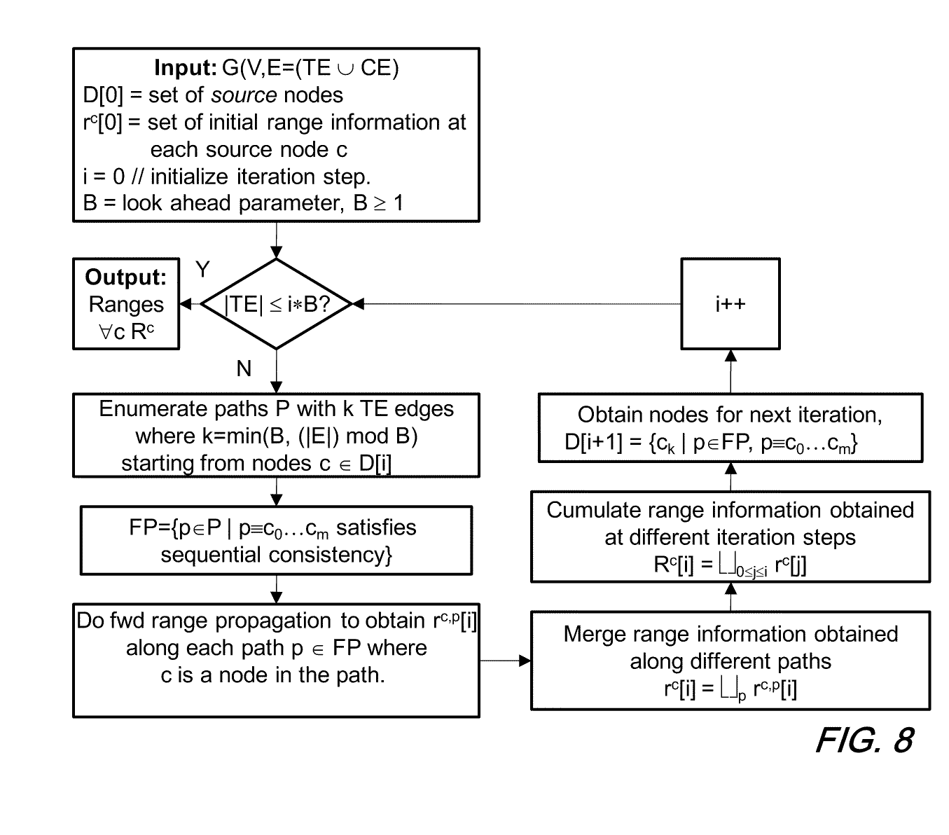

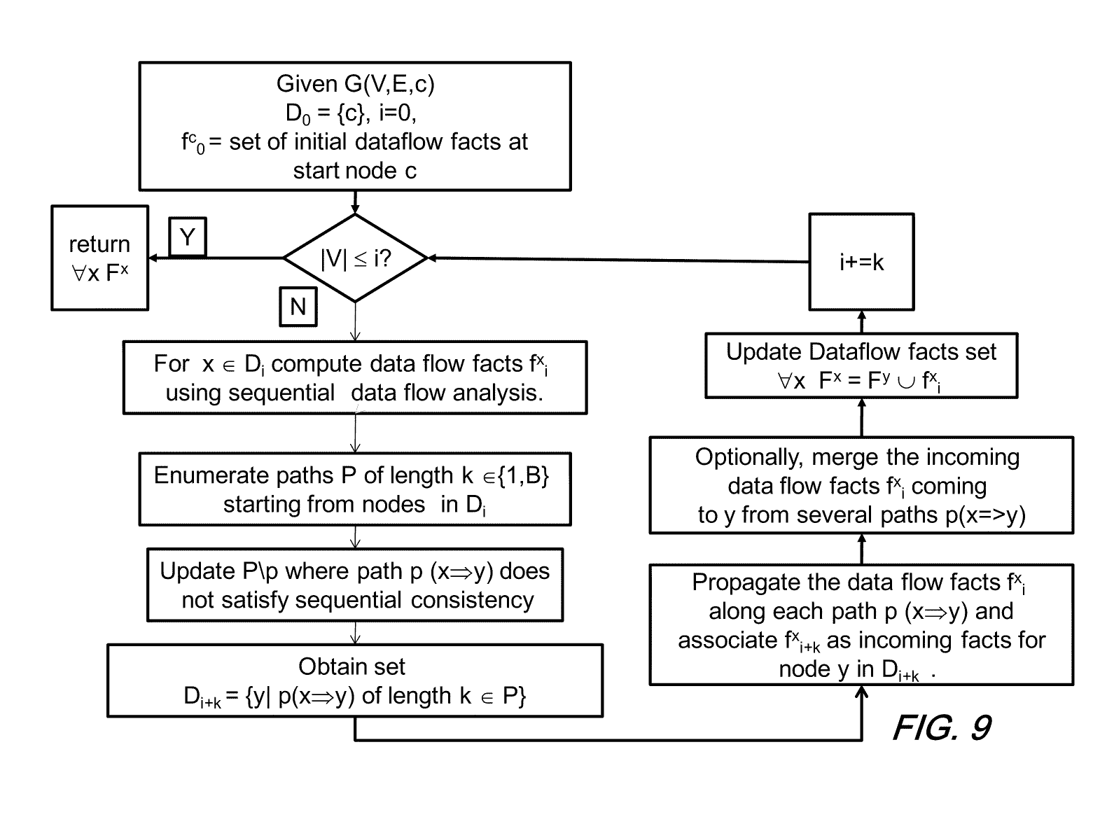

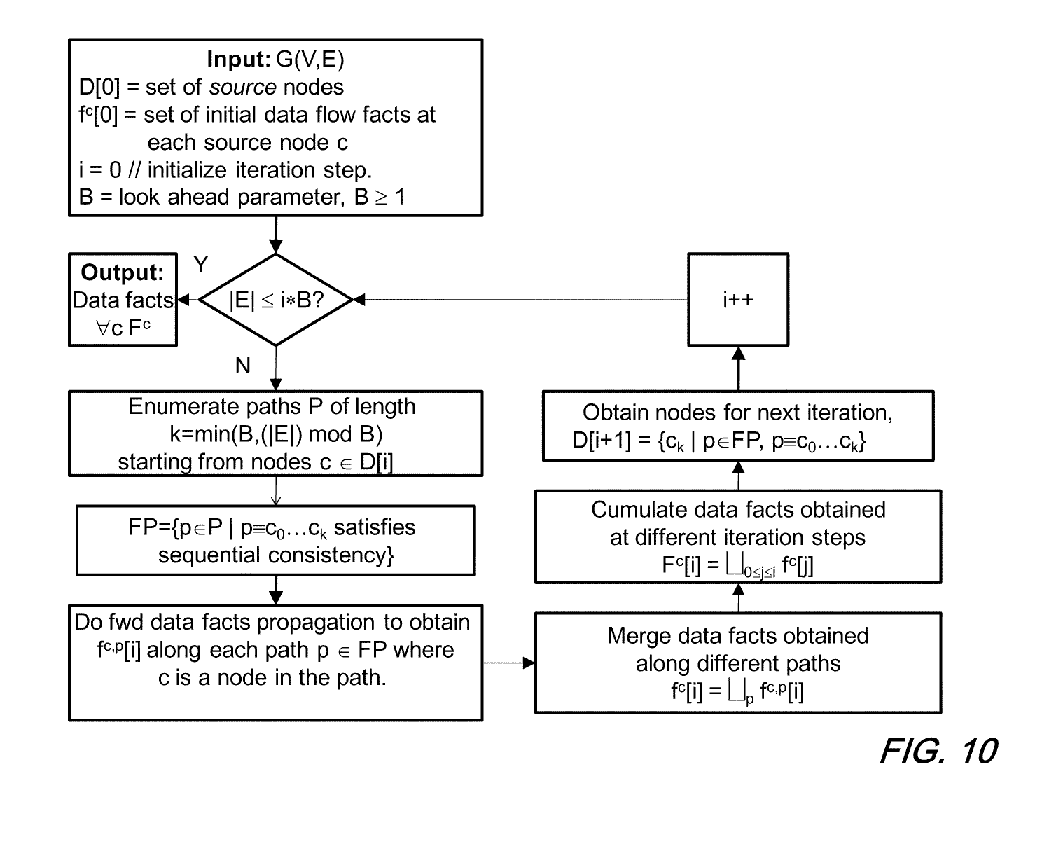

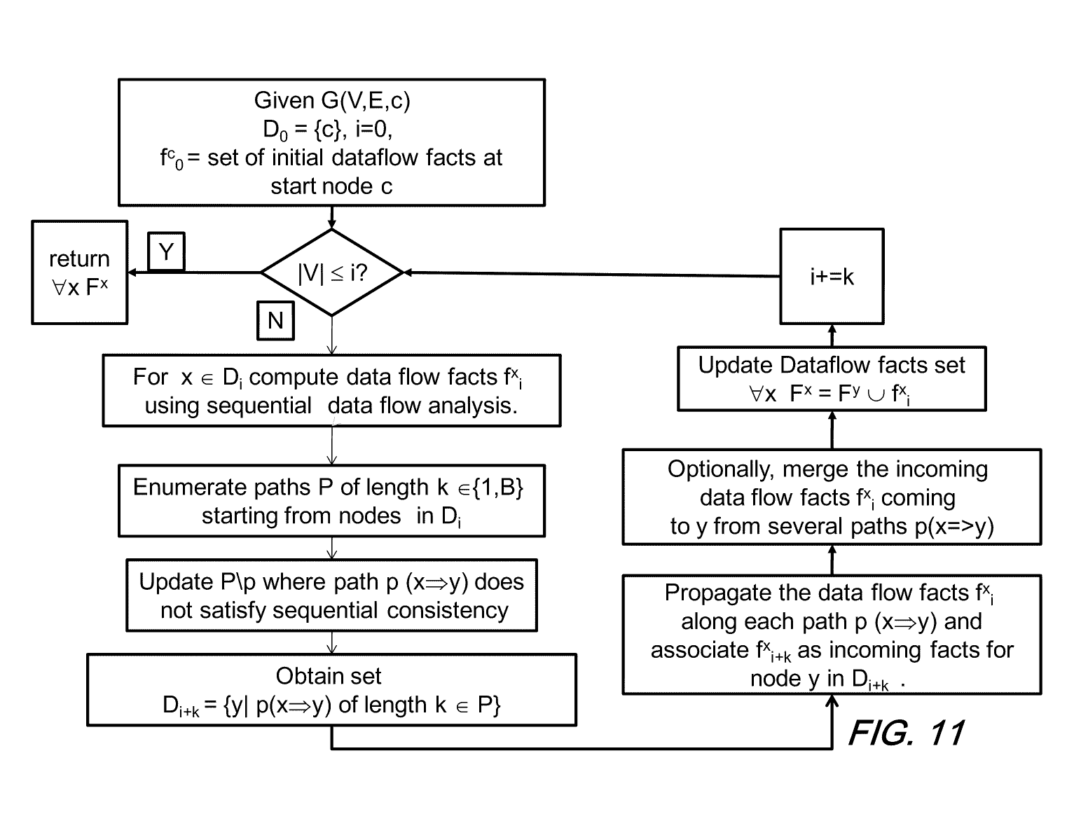

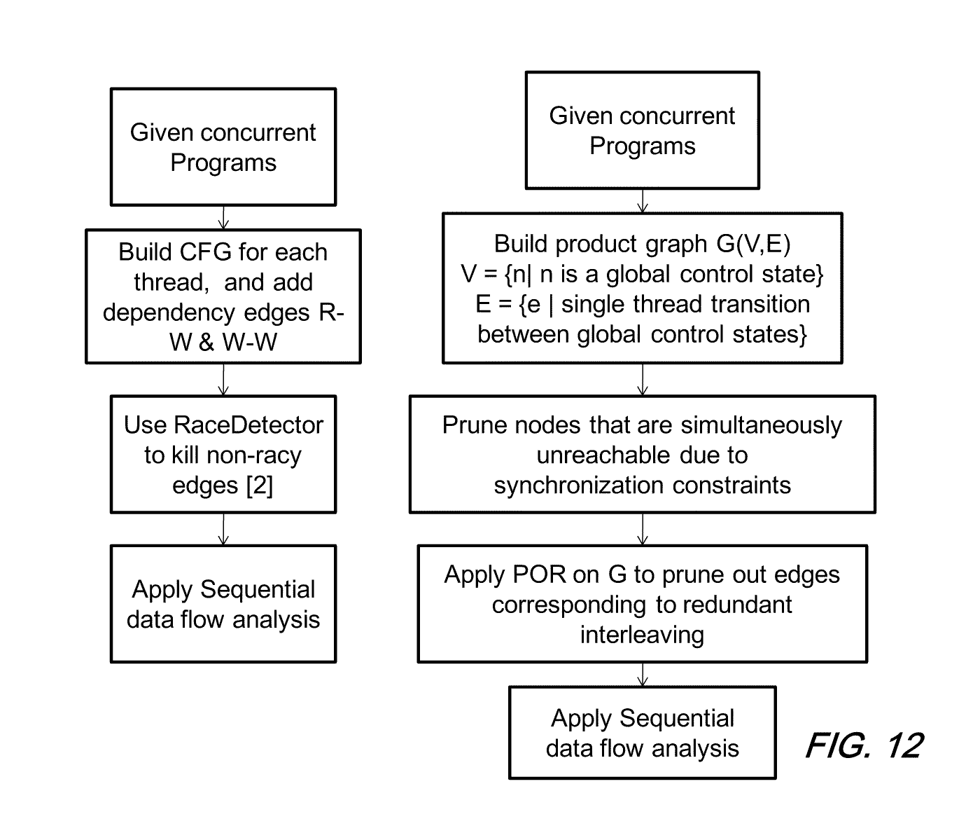

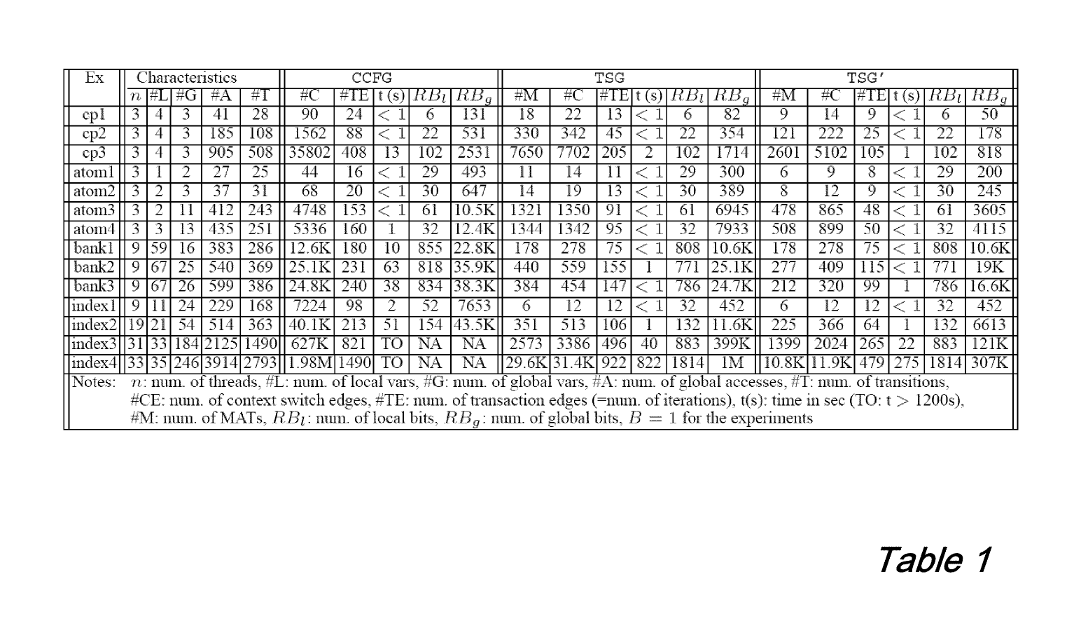

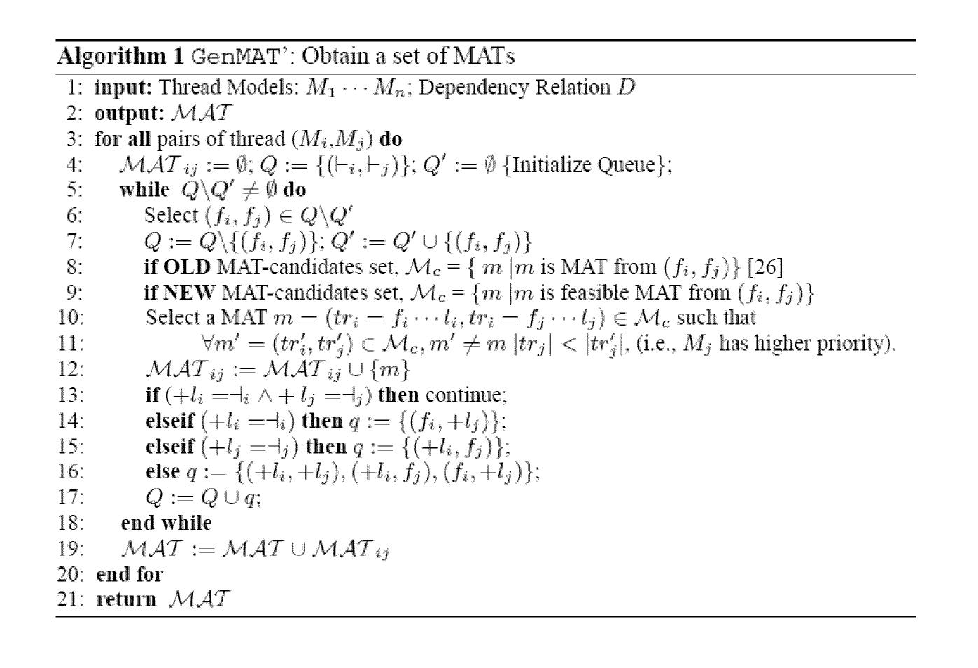

Finally, given G′, we perform dataflow analysis as explained in FIG. 8.

Turning now to that FIG. 8—there is shown a flow diagram depicting the more detailed dataflow analysis. We define Dᵢ to denote the set of nodes at each iteration depth i. We use f^{c,p}[i] to denote the dataflow facts at node c along a feasible path p. As noted earlier, a feasible path does not have cycle, and therefore, f^{c,p}[i] is uniquely defined. We define f^{c}[i] to denote dataflow facts associated with node c at depth i, accumulated over all paths, i.e., f^{c}[i]=∪ₚf^{c,p}[i]. We define cumulative dataflow facts depth i as F^{c}[i]=∪ₜ₋₀^{t=i}f^{c}[i] where cεD[i] where ∪ is operator for union of dataflow facts. We use F^{c} to denote the final cumulative dataflow facts at node c when the iterative procedure stops.

We let FP denote a set of feasible paths starting from nodes D[i] of length B>0, where B is a lookahead parameter that controls the trade-off between precision and update cost. Given G(V,E,c), we obtain initialized the set of nodes D₀={c}. We also have the set f^{c}₀ with the initial dataflow facts at node c.

We iterate over the loop for ┌|E|/B┐ times, as the longest feasible path can have |E| edges.(block 2-3).

At each iteration, we enumerate a set of paths pεP where p=c₀ . . . cₖ with length k starting from c₀ εD[i]. We choose k=B for all but the last iteration, and k=(|E|) mod B for the last iteration.

From the set P, we obtain a set of feasible paths FP, where each path p c FP satisfies sequential consistency requirements.

Along each path pε FP, we perform forward data facts propagation to obtain f^{c,p}[i] where c is a node in the path p. If an edge corresponds to a loop summary, we use a fixed point computation under suitable abstract domain.

We merge the dataflow facts obtained along different paths, i.e., f^{c}[i]=∪_{pεFP} f^{c,p}[1].

We also cumulate dataflow facts obtained up to the current iteration step for each node c, and represent it as F^{c}[i].

Finally, for the next iteration, we obtain a set of nodes D[i+1] corresponding to the ending nodes of the paths p εFP.

At this point, while we have discussed and described the invention using some specific examples, those skilled in the art will recognize that our teachings are not so limited. Accordingly, the invention should be only limited by the scope of the claims attached hereto.

1. A computer implemented method of dataflow analysis for a concurrent computer program comprising the steps of:
by a computer
constructing a transaction sequence graph (TSG) representative of the concurrent computer program;
determining a bounded number of global data flow updates and fixed points on loops and interacting loops on the TSG, and
outputting a set of values indicative of the data flow analysis.

2. The computer implemented method according to claim 1 further comprising the steps of:
reducing the constructed TSG by merging and removing edges of the TSG using the results of a Mutual Atomic Transaction (MAT) analysis.

3. The computer implemented method according to claim 2 further comprising the steps of:
reducing the constructed TSG by merging and removing edges using the results of a MAT analysis wherein the MAT analysis only considers feasible MATs.

4. The computer implemented method according to claim 1 further comprising the steps of:
propagating any dataflow facts along paths that are sequentially consistent.

5. The computer implemented method according to claim 4 wherein all paths exhibit a bounded number of context switches.

6. The computer implemented method according to claim 1 further comprising the steps of:
obtaining a set of adequate ranges for small domain encoding of any decision problems arising from concurrent program verification.
